(19) United States
(12) Patent Application Publication
(10) Pub. No.: US 2018/0216983 A1
(43) Pub. Date: Aug. 2, 2018

(54) SOLID STATE FUEL LEVEL SENSOR

(71) Applicant: Eaton Corporation, Cleveland, OH (US)

(72) Inventor: Robert P. Benjey, Dexter, MI (US)

(73) Assignee: Eaton Corporation, Cleveland, OH (US)

(21) Appl. No.: 15/938,329

(22) Filed: Mar. 28, 2018

Related U.S. Application Data
(63) Continuation of application No. PCT/US2016/054140, filed on Sep. 28, 2016.
(60) Provisional application No. 62/233,780, filed on Sep. 28, 2015.

(51) Int. Cl. G01F 23/18; G01N 9/26; G01F 23/00

(52) U.S. Cl. CPC G01F 23/18; B60K 2015/03217; G01F 23/0092; G01N 9/26

(57) ABSTRACT

A solid state fuel level sensor system disposed in a fuel tank according to one example of the present disclosure includes a first pressure sensor, a second pressure sensor, a reference chamber, a liquid discriminating membrane and a reference tube. The first pressure sensor is disposed in the fuel tank. The second pressure sensor is disposed in the fuel tank. The first and second pressure sensors are separated a vertical distance from each other in the fuel tank. The reference chamber is fluidly connected to the first and second pressure sensors. The reference tube is fluidly connected between the reference chamber and the liquid discriminating membrane. The reference tube extends into a vapor space of the fuel tank at the liquid discriminating membrane such that a vapor pressure at the vapor space is communicated into the reference chamber.

### CROSS-REFERENCE TO RELATED APPLICATIONS

This application is a continuation of International Application No. PCT/US2016/054140 filed on Sep. 28, 2016, which claims the benefit of U.S. Patent Application No. 62/233,780 filed on Sep. 28, 2015. The disclosure of the above application is incorporated herein by reference.

### FIELD

The present disclosure relates generally to fuel tanks on passenger vehicles and more particularly to a solid state fuel level sensor system for a vehicle fuel system.

### BACKGROUND

The present disclosure relates to systems for sensing and indicating the fuel reserve in a fuel tank such as those that contain volatile fuel such as gasoline or mixtures of gasoline and methanol. Where vapor pressure is accumulated in the fuel tank above the liquid fuel level, and particularly at elevated ambient temperature conditions in closed fuel vapor vent systems, the increased vapor pressure can significantly increase the effective density of the fuel. In one current fuel level sensor configuration an upper pressure transducer is arranged in the vapor space of the fuel tank. In one example, the pressure transducer is mounted on an underside of the upper wall of the fuel tank at its highest point for sensing vapor pressure above the liquid level of the fuel. In this arrangement one or more lower pressure transducers are arranged near the bottom of the tank and configured to measure a pressure. Fluid head pressure can then be determined based on the vapor pressure at the upper pressure transducer and the measured pressure from the lower pressure transducer(s).

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A solid state fuel level sensor system disposed in a fuel tank according to one example of the present disclosure includes a first pressure sensor, a second pressure sensor, a reference chamber, a liquid discriminating membrane and a reference tube. The first pressure sensor is disposed in the fuel tank. The second pressure sensor is disposed in the fuel tank. The first and second pressure sensors are separated a vertical distance from each other in the fuel tank. The reference chamber is fluidly connected to the first and second pressure sensors. The reference tube is fluidly connected between the reference chamber and the liquid discriminating membrane. The reference tube extends into a vapor space of the fuel tank at the liquid discriminating membrane such that a vapor pressure at the vapor space is communicated into the reference chamber.

According to additional features, the liquid discriminating membrane inhibits liquid fuel from entering the reference tube. The liquid discriminating membrane includes a rubber diaphragm. In another example the liquid discriminating membrane includes a urethane membrane.

In other features, the first pressure sensor is a solid state differential pressure sensor having a low pressure side and a high pressure side. The second pressure sensor is a solid state differential pressure sensor having a low pressure side and a high pressure side. The low pressure sides of both of the first and second pressure sensors measure a pressure at the reference chamber.

According to other features, the solid state fuel level sensor system further comprises a controller. The controller computes a fuel density based on pressures sensed at the first and second pressure sensors. The controller further computes fuel density based on the vertical distance. The controller can determine a fuel reserve volume from a lookup table of fuel reserve volume values as a function of values of fuel level for a known tank configuration. The controller can output a signal to a display indicative of the determined fuel reserve volume. The first and second pressure sensors are solid state pressure transducers.

A method for determining an amount of liquid fuel in a vehicle fuel tank according to one example of the present disclosure includes providing a first pressure sensor in the fuel tank that senses a first differential pressure. A second pressure sensor is provided in the fuel tank that is separated a vertical distance from the first pressure sensor. The second pressure sensor senses a second differential pressure. A liquid head pressure is determined from the second pressure sensor. A fuel density of the liquid fuel is determined.

According to additional features, a height between the first and second pressure sensors is determined. A difference between a first pressure measured at the first pressure sensor and a second pressure measured at the second pressure sensor is determined. The density is based on the difference and the height. A fuel height is determined based on the liquid head pressure and the fuel density. A fuel reserve volume of the fuel tank is determined as a function of fuel height. A signal is communicated to a display indicative of the fuel reserve volume.

A solid state fuel level sensor system disposed in a fuel tank according to another example of the present disclosure consists of a first pressure sensor, a second pressure sensor and a reference tube. The first pressure sensor is disposed in the fuel tank. The second pressure sensor is disposed in the fuel tank. The first and second pressure sensors are separated a vertical distance from each other in the fuel tank. The reference tube communicates with the first and second pressure sensors and extends into a vapor space of the fuel tank. A differential pressure is measured without measuring vapor pressure within the fuel tank. A fuel reserve volume is determined based on a density of liquid fuel in the fuel tank and a liquid head pressure from the second pressure sensor.

### BRIEF DESCRIPTION OF THE DRAWINGS

The present disclosure will become more fully understood from the detailed description and the accompanying drawings, wherein:

FIG. 1 is a schematic illustration of a fuel tank configuration incorporating a reference tube according to one example of the present disclosure;

FIG. 2 is a schematic illustration of a fuel tank control system that determines a liquid fuel volume in the fuel tank of FIG. 1; and

FIG. 3 is a flow diagram of a method of determining the liquid fuel volume using the fuel tank control system of FIG. 2.

### DETAILED DESCRIPTION

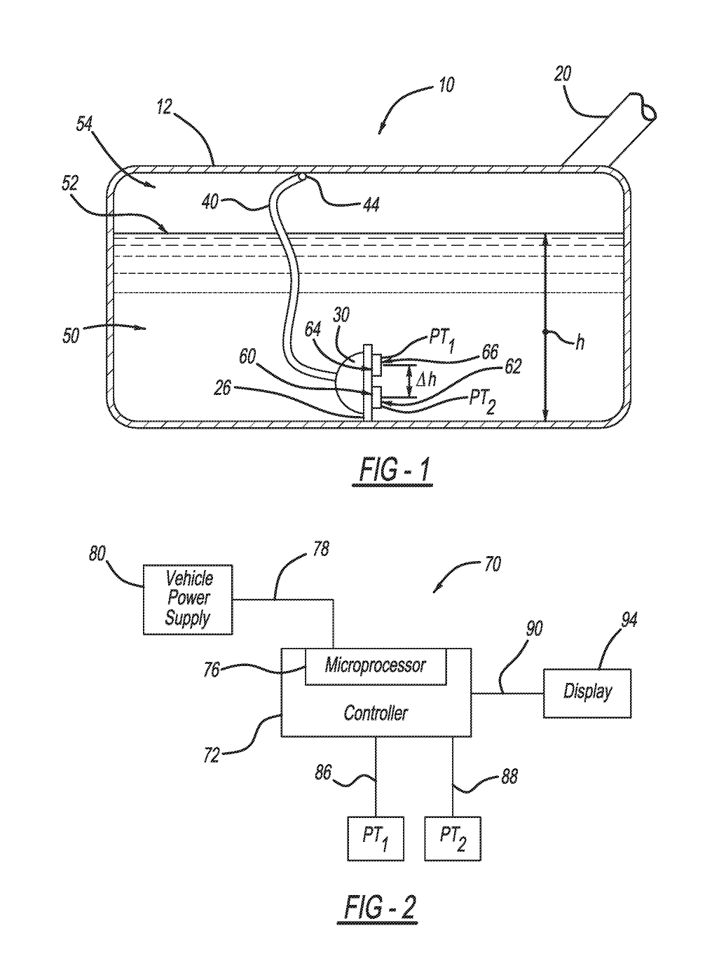

With initial reference to FIG. 1, a solid state fuel level sensor system constructed in accordance to one example of the present disclosure is shown and generally identified at reference numeral 10. The solid state fuel level sensor system 10 is shown implemented in a fuel tank 12 having a filler tube or neck 20. A first solid state pressure sensor PT₁ and a second solid state pressure sensor PT₂ are supported on a bracket 26 supported by the bottom of the fuel tank 12. A reference chamber 30 is fluidly connected to the first and second solid state pressure sensors PT₁ and PT₂. A reference tube 40 is fluidly connected between the reference chamber 30 and a liquid discriminating membrane 44. The liquid discriminating membrane 44 can include a rubber diaphragm or urethane member. Other configurations are contemplated. The liquid discriminating membrane 44 can preclude liquid fuel from entering the reference tube 40. As illustrated in FIG. 1, the fuel tank 12 has a volume of liquid fuel 50 stored therein. The liquid fuel 50 has a liquid fuel level 52 that extends a distance h from a bottom of the fuel tank 12. A vapor space 54 is defined within the fuel tank 12 generally above the liquid fuel level 52.

As will become appreciated from the following discussion, the solid state fuel level sensor system 10 determines a fuel reserve volume using a differential pressure based on the first and second solid state pressure sensors PT₁ and PT₂. In the example shown, the first and second solid state pressure sensors PT₁ and PT₂ are differential pressure sensors. The first solid state pressure sensor PT₁ has a low pressure side 60 and a high pressure side 62. The second solid state pressure sensor PT₂ has a low pressure side 64 and a high pressure side 66. The first solid state pressure sensor PT₁ measures the difference between the pressures at the low pressure side 60 and the high pressure side 62. The second solid state pressure sensor PT₂ measures the difference between the pressures at the low pressure side 64 and the high pressure side 66. The low pressure sides 60 and 64 of the respective first and second solid state pressure sensors PT₁ and PT₂ measure a pressure consistent with the reference chamber 30.

The vapor pressure observed in the vapor space 54 can be communicated to the reference chamber 30 through the reference tube 40. The vapor pressure therefore acts on the low pressure sides 60 and 64 of the first and second solid state pressure sensors PT₁ and PT₂, respectively. Because a differential pressure is determined, the vapor pressure that may exist in the vapor space 54 can be already accounted for and need not be specifically determined with a supplemental pressure sensor mounted in the vapor space 54. As a result, only two pressure sensors are required to accurately determine fuel reserve volume.

Turning now to FIG. 2, a schematic illustration of a fuel tank control system 70 that determines a liquid fuel volume in the fuel tank 12 is shown. A controller 72 includes a microprocessor 20 therein. The controller is electrically coupled through line 78 to a vehicle power supply 80. The pressure sensor PT₁ is electrically coupled through line 86 to the controller 72. The pressure sensor PT₂ is electrically coupled through line 88 to the controller 72. It is appreciated that the electrical leads within the fuel tank 10 corresponding to the lines 78, 86 and 88 have been omitted for simplicity of illustration of FIG. 1. The controller 72 provides an output along line 90 to a remote display 94 which in the present disclosure of a motor vehicle would comprise a fuel level indicator on the operator's instrument panel.

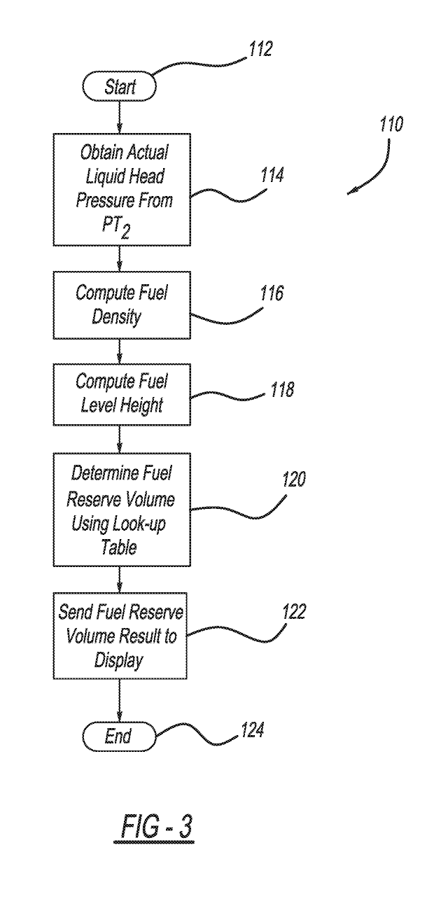

With reference to FIG. 3, a method of determining the liquid fuel volume using the fuel tank control system 70 is shown and generally identified at reference numeral 110. The method starts at 112. At 114, control obtains an actual liquid head pressure. In the example provided, the pressure sensor PT₂ senses liquid head pressure (P_{H}). At 116, control computes a fuel density. In the example shown, density can be determined from the pressures measured from the first and second pressure sensors PT₁ and PT₂ as well as a known height (Δh) between the first and second pressure sensors PT₁ and PT₂. For example, density ρ can be represented by (PT₁−PT₂)/Δh. At 118 a fuel level height can be determined based on the pressure P_{H} measured by the pressure sensor PT₂ and the computed density. For example, fuel level height can be represented by P_{H}/ρ(g). Once control has determined fuel density ρ and fuel level height, control determines a fuel reserve volume. At 120, control determines a fuel reserve volume V_{R} as a function of fuel level h using a look-up table. In general, the reserve volume V_{R} of fuel is obtained from a lookup table of tank volume as a function of values of fuel level h for known tank configurations. Control sends the fuel reserve volume value to the display 94 at 122. Control ends at 124.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A solid state fuel level sensor system disposed in a fuel tank, the solid state fuel level sensor system comprising:
a first pressure sensor disposed in the fuel tank;
a second pressure sensor disposed in the fuel tank, the first and second pressure sensors separated a vertical distance from each other in the fuel tank;
a reference chamber fluidly connected to the first and second pressure sensors;
a liquid discriminating membrane; and
a reference tube fluidly connected between the reference chamber and the liquid discriminating membrane, the reference tube extending into a vapor space of the fuel tank at the liquid discriminating membrane such that a vapor pressure at the vapor space is communicated into the reference chamber.

2. The solid state fuel level sensor system of claim 1 wherein the liquid discriminating membrane inhibits liquid fuel from entering the reference tube.

3. The solid state fuel level sensor system of claim 1 wherein the liquid discriminating membrane includes a rubber diaphragm.

4. The solid state fuel level sensor system of claim 1 wherein the liquid discriminating membrane includes a urethane member.

5. The solid state fuel level sensor system of claim 1 wherein the first pressure sensor is a solid state differential pressure sensor having a low pressure side and a high pressure side.

6. The solid state fuel level sensor system of claim 5 wherein the second pressure sensor is a solid state differential pressure sensor having a low pressure side and a high pressure side.

7. The solid state fuel level sensor system of claim 6 wherein the low pressure sides of both of the first and second pressure sensors measure a pressure at the reference chamber.

8. The solid state fuel level sensor system of claim 1, further comprising a controller wherein the controller computes a fuel density based on pressures sensed at the first and second pressure sensors.

9. The solid state fuel level sensor system of claim 8 wherein the controller further computes fuel density based on the vertical distance.

10. The solid state fuel level sensor system of claim 9 wherein the controller determines a fuel reserve volume from a lookup table of fuel reserve volume values as a function of values of fuel level for a known tank configuration.

11. The solid state fuel level sensor system of claim 10 wherein the controller outputs a signal to a display indicative of the determined fuel reserve volume.

12. The solid state fuel level sensor system of claim 1 wherein the first and second pressure sensors are solid state pressure transducers.

13. A method for determining an amount of liquid fuel in a vehicle fuel tank, the method comprising:
providing a first pressure sensor in the fuel tank that senses a first differential pressure;
providing a second pressure sensor in the fuel tank that is separated a vertical distance from the first pressure sensor, the second pressure sensor sensing a second differential pressure;
determining liquid head pressure from the second pressure sensor; and
determining a fuel density of the liquid fuel.

14. The method of claim 13 wherein determining fuel density comprises:
determining a height between the first and second pressure sensors.

15. The method of claim 14 wherein determining fuel density further comprises:
determining a difference between a first pressure measured at the first pressure sensor and a second pressure measured at the second pressure sensor, the density based on the difference and the height.

16. The method of claim 15, further comprising:
determining a fuel level height based on the liquid head pressure and the fuel density.

17. The method of claim 16, further comprising:
determining a fuel reserve volume of the fuel tank as a function of fuel level height.

18. The method of claim 17, further comprising:
communicating a signal to a display indicative of the fuel reserve volume.

19. A solid state fuel level sensor system disposed in a fuel tank, the solid state fuel level sensor system consisting of:
a first pressure sensor disposed in the fuel tank;
a second pressure sensor disposed in the fuel tank, the first and second pressure sensors separated a vertical distance from each other in the fuel tank; and
a reference tube communicating with the first and second pressure sensors and that extends into a vapor space of the fuel tank, wherein a differential pressure is measured without measuring vapor pressure within the fuel tank.

20. The solid state fuel level sensor system of claim 19 wherein a fuel reserve volume is determined based on a density of liquid fuel in the fuel tank and a liquid head pressure from the second pressure sensor.
